(19) United States
(12) Patent Application Publication
(10) Pub. No.: US 2008/0112745 A1
(43) Pub. Date: May 15, 2008

(54) SHEET CONVEYING APPARATUS AND IMAGE FORMING APPARATUS

(75) Inventor: Hiroshi Saito, Kashiwa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/937,753

(22) Filed: Nov. 9, 2007

(30) Foreign Application Priority Data
Nov. 15, 2006 (JP) 2006-308517

(51) Int. Cl. G03G 15/00

(52) U.S. Cl. 399/361

(57) ABSTRACT

A sheet conveying apparatus according to the invention includes a stator in which many electrode groups are provided in parallel in a direction orthogonal to a sheet conveying direction, plural belt-like electrodes being provided in parallel at predetermined intervals in the sheet conveying direction; a power supply which applies at least two types of voltages to the electrode groups of the stator; and control unit which controls the voltages while switching the voltages applied to the electrode groups of the stator from the power supply, wherein the control unit controls the voltages while switching the voltages such that the sheet is conveyed in a direction in which the electrodes of the stator are provided in parallel, and the control unit controls a switching period of the voltages such that the switching period is changed in each electrode group to rotate the sheet.

### BACKGROUND OF THE INVENTION

1. Field of the Invention

The present invention relates to a sheet conveying apparatus for utilizing an electrostatic force to convey a sheet and an image forming apparatus including the sheet conveying apparatus.

2. Description of the Related Art

Conventionally, in the image forming apparatus such as a copying machine and a printer, the sheet conveying apparatus conveys the sheet using a conveying roller which is rotated by a driving mechanism including a motor, an electromagnetic clutch, and a gear. In correcting an inclination of the sheet relative to a sheet conveying direction, i.e., skew feeding, the sheet is caused to abut on a tentatively-stopped registration roller to form a loop in the sheet, and then the registration roller is restarted to remove the sheet inclination. Alternatively, the sheet is caused to abut on an abutting plate parallel to the conveying direction using a roller for conveying the sheet in an oblique direction, or a difference in speed is provided between a front side and a rear side in an axial direction of the roller for conveying the sheet, whereby the sheet inclination is corrected into a desired angle.

However, because it is necessary to tentatively stop the sheet conveyance in the method of forming the loop in the sheet with the registration roller, unfortunately high productivity cannot be achieved. In other methods, a stress is applied to the sheet by the roller, and a wrinkle or a flaw is possibly generated when particularly the sheet having low stiffness such as thin paper is conveyed. In the case of the sheet having the low stiffness, a corner of the sheet is possibly folded when abutting on the abutting plate. When the sheet is conveyed using the roller for conveying the sheet in the oblique direction or the roller in which the difference in speed is provided, the complicated mechanism is required because it is necessary to open movement of the sheet by releasing pressures of roller pairs for nipping and conveying the sheet on the upstream and downstream sides of the roller.

Therefore, there is proposed a conveying apparatus which utilizes an electrostatic force to convey the sheet without nipping the sheet (for example, see Japanese Patent Application Laid-Open No. 8-12118). In the sheet conveying apparatus disclosed in Japanese Patent Application Laid-Open No. 8-12118, two belt-like electrode groups provided at a predetermined interval in a direction perpendicular to the sheet conveying direction are provided on either side in the sheet conveying direction, and voltages are applied to the electrodes, whereby the electrostatic force is utilized to convey the sheet. In the case where the sheet is positioned, the two electrode groups located on either side are driven at different conveying speeds, and the sheet is rotated and positioned by the difference in conveying speed.

As described above, in the sheet conveying apparatus disclosed in Japanese Patent Application Laid-Open No. 8-12118, because the sheet is rotated by the difference in conveying speed between the two electrode groups located on either side in positioning the sheet, the difference in conveying speed between the two electrode groups is increased as the sheet inclination is increased. Therefore, in the case of the sheet having the low stiffness, the sheet is possibly twisted to generate the wrinkle due to the difference in conveying speed between the two electrode groups. That is, even in the sheet conveying apparatus in which the electrostatic force is utilized, there is a limitation in the thickness (stiffness) of the sheet which can be positioned.

In view of the foregoing, an object of the invention is to provide a sheet conveying apparatus in which the skew feeding can be corrected while even the sheet having the low stiffness is conveyed without applying the unnecessary stress.

### SUMMARY OF THE INVENTION

In accordance with the invention, a sheet conveying apparatus includes a stator in which many electrode groups are provided in parallel in a direction orthogonal to a sheet conveying direction, plural belt-like electrodes being provided in parallel at predetermined intervals in the sheet conveying direction; a power supply which applies at least two types of voltages to the electrode groups of the stator; and control unit which controls the at least two types of the voltages while switching the voltages applied to the electrode groups of the stator from the power supply, wherein the control unit controls the voltages while switching the voltages applied to the electrodes such that the sheet is conveyed in a direction in which the electrodes of the stator are provided in parallel, and the control unit controls a switching period of the voltages applied to the electrode groups of the stator such that the switching period is changed in each electrode group to rotate the sheet.

In the invention, the many electrode groups including the plural electrodes provided in parallel in the sheet conveying direction are provided in the direction orthogonal to the sheet conveying direction, so that the difference in sheet conveying speed between the adjacent electrode groups can be decreased as much as possible even if the sheet is rotated. Accordingly, the skew feeding correction can be realized while even the sheet having the low stiffness is conveyed without applying the unnecessary stress.

Further features of the present invention will become apparent from the following description of exemplary embodiments (with reference to the attached drawings).

### BRIEF DESCRIPTION OF THE DRAWINGS

FIG. 1 is a sectional view showing an entire configuration of an image forming apparatus;

FIG. 2 shows stator electrode arrangement for explaining a principle of electrostatic conveyance;

FIG. 3 shows a pattern of voltages applied to a stator for explaining the principle of electrostatic conveyance;

FIG. 4 is a plan view showing the stator electrode arrangement;

FIG. 5 is a perspective view showing the stator constituting a sheet conveying path;

FIG. 6 is a plan view showing a sheet inclination correcting operation on the stator;

FIG. 7 is a control block diagram of a sheet conveying apparatus; and

FIG. 8 is a timing chart showing a voltage applied to a stator electrode in time series.

### DESCRIPTION OF THE EMBODIMENTS

An exemplary embodiment of the invention will be described below with reference to the drawings. However, sizes, materials, and shapes of components described in the following embodiments and a relative arrangement among the components shall appropriately be changed depending on a configuration and various conditions of an apparatus to which the invention is applied. Accordingly, the invention is not limited to the sizes, materials, shapes, and relative arrangement of the embodiments unless otherwise noted.

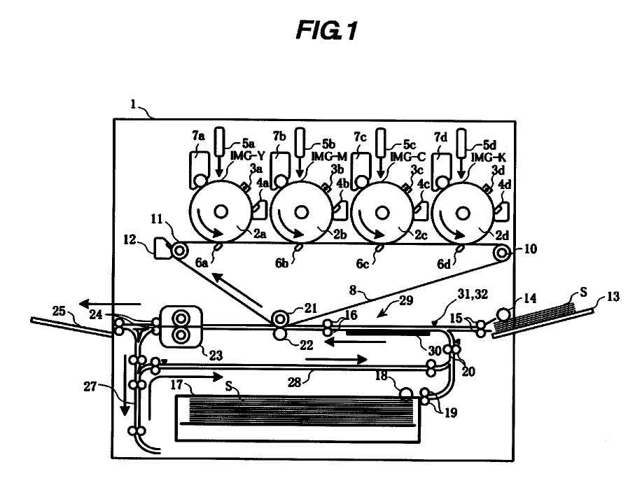

FIG. 1 is a sectional view showing an entire configuration of an image forming apparatus including a sheet conveying apparatus in which the electrostatic force is utilized, and FIG. 1 illustrates a schematic configuration of an electrophotographic-system full-color printer.

FIG. 1 shows a printer main body 1, four-color photosensitive drums 2a to 2d, chargers 3a to 3d, cleaners 4a to 4d, laser scanning units 5a to 5d, transfer blades 6a to 6d, and development units 7a to 7d. There are also shown in FIG. 1 an intermediate transfer belt 8, rollers 10 and 11 which support the intermediate transfer belt 8, and a cleaner 12.

FIG. 1 also shows a manual feed tray 13 in which sheets S are stored, pickup rollers 14 and 15, and a registration roller 16; a sheet cassette 17 in which the sheets S are stored, pickup rollers 18 and 19 for the sheet cassette 17, and a longitudinal path roller 20. There are also shown in FIG. 1 a rotating roller 21, a secondary transfer roller 22, a fixing device 23, a discharge roller 24, and a discharge tray 25.

In the printer having the configuration of FIG. 1, the laser scanning units 5a to 5d which have semiconductor lasers as a light source form color electrostatic latent images on the photosensitive drum 2a to 2d respectively, and the development devices 7a to 7d develop the electrostatic latent images respectively. Color toner images developed on the photosensitive drums 2a to 2d are respectively transferred onto the intermediate transfer belt 8 by the transfer blades 6a to 6d while superposed one another. The toner images which transferred onto the transfer belt 8 while superposed one another are collectively transferred to the sheet S by the secondary transfer roller 22. In the toner images collectively transferred to the sheet S, a fixing unit including the fixing device 23 and the discharge roller 24 melts the toner to form the permanent image.

On the other hand, the sheet S is selectively fed from the sheet cassette 17 or manual feed tray 13. A sheet conveying apparatus 29 utilizes an electrostatic force to convey the sheet S to the secondary transfer roller 22 while the sheet S is synchronized with the image using the registration roller 16. At this point, stepping motors separately drive the sheet conveying portions such as the pickup rollers 18 and 19 which feed the sheet S from the sheet cassette 17, the longitudinal path roller 20, the registration roller 16, and the pickup rollers 14 and 15 which feed the sheet S from the manual feed tray 13, which allows a conveying operation to be stably realized at high speed.

During duplex printing, the sheet passing through the fixing device 23 and discharge roller 24 is guided in a direction of a duplex reversing path 27, and the sheet S is reversely conveyed to a duplex path 28. The sheet S which passes already through the duplex path 28 passes through the longitudinal path roller 20 again. Then, similarly to the first surface, the image is formed, transferred, and fixed on a second surface, and the sheet is discharged.

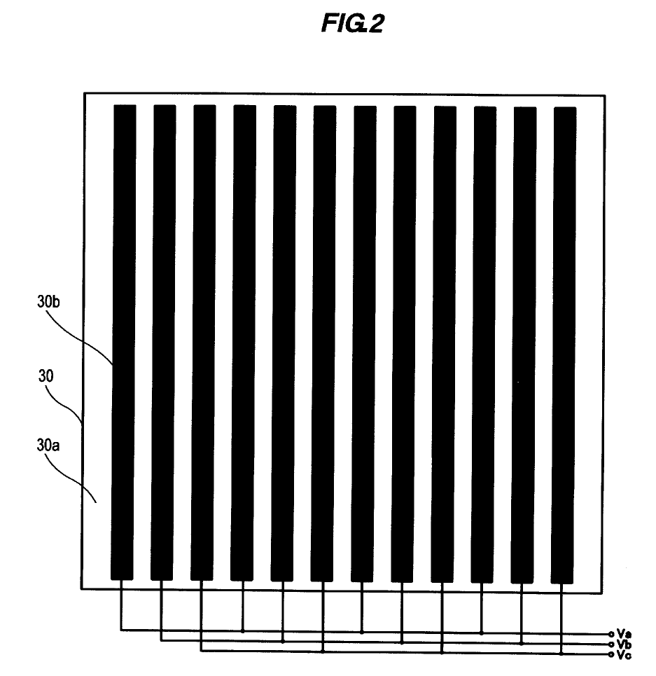

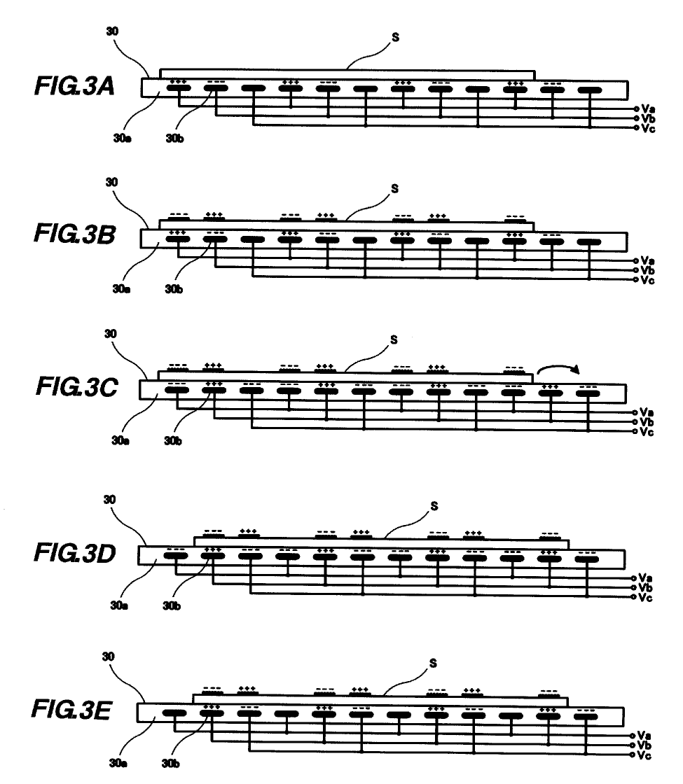

The sheet conveying apparatus 29 which utilizes the electrostatic force to convey the sheet will be described below. A basic configuration of the stator included in the sheet conveying apparatus 29 will be described with reference to FIG. 2, and a principle utilizing the electrostatic force to convey the sheet will be described with reference to FIG. 3.

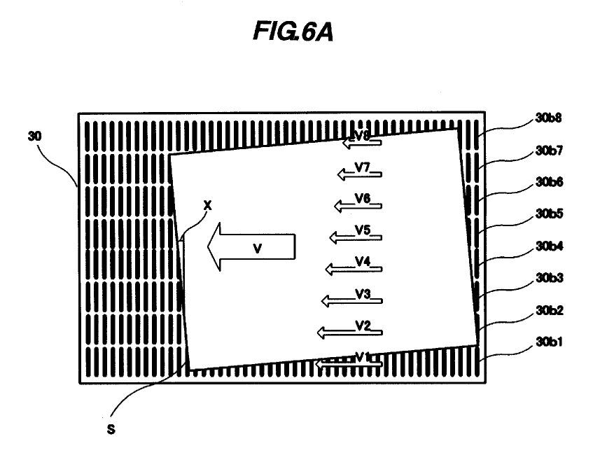

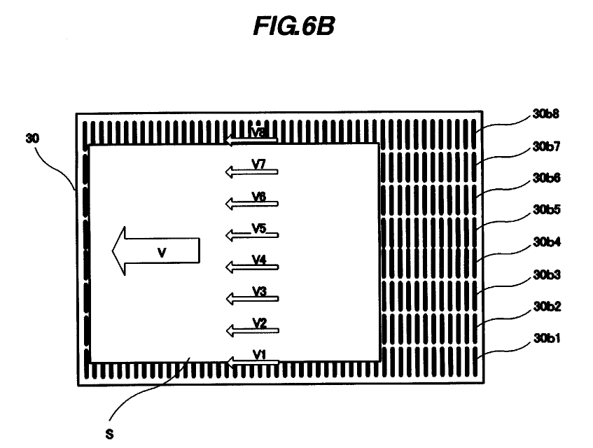

FIG. 2 is a plan view showing the stator in which plural electrodes are arranged in parallel at predetermined intervals in a sheet conveying direction. FIG. 2 shows a stator 30 which includes an insulator 30a and plural belt-like electrodes 30b. The insulator 30a is provided in one of surfaces of the sheet conveying path (in this case, lower surface side of the sheet), and the electrodes 30b are arranged in a comb shape at predetermined intervals in the surface of the insulator 300a. The electrodes 30b are configured such that at least two types of voltages are applied from a power supply. In this case, the electrodes 30b are divided into three groups and the electrodes of the groups are alternately arranged. Three types of voltages Va, Vb, and Vc are applied to the electrodes 30b of the groups from a power supply (numeral 34 in FIG. 6) for the stator. The voltages Va, Vb, and Vc are applied which switched at predetermined conditions by a control unit (numeral 33 in FIG. 6).

FIG. 3 is a sectional view schematically showing the stator 30 of FIG. 2, and FIG. 3 shows a sequence of the sheet conveyance. In the state in which the sheet S is in contact with the stator 30, the different voltages Va, Vb, and Vc are applied to the groups of the electrodes 30b.

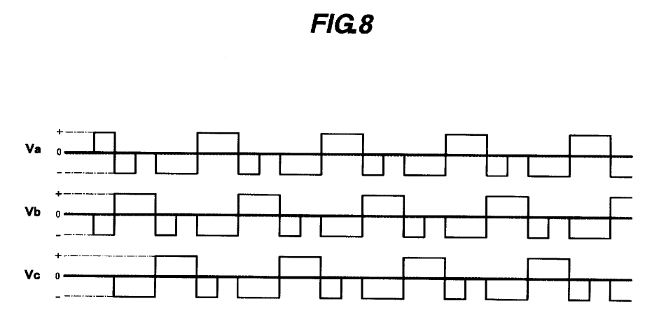

When Va=1000V, Vb=−1000V, and Vc=0V are applied to the groups of the electrodes 30b as shown in FIG. 3A, a charge pattern is transferred to the sheet S as shown in FIG. 3B. When Va=−1000V, Vb=1000V, and Vc=−1000V are applied to the groups of the electrodes 30b as shown in FIG. 3C, the sheet S is moved as shown in FIG. 3D. As shown in FIG. 3E, Va=0V, Vb=1000V, and Vc=−1000V are applied to the groups of the electrodes 30b to recharge the charges lost during the movement. Then, the processes from FIG. 3C to FIG. 3E are repeated to convey the sheet S. Thus, the conveying force for conveying the sheet is generated by the above-described principle. A voltage applying pattern of FIG. 8 is obtained when the time series of the sequence is expressed in each of the voltages Va, Vb, and Vc applied to the electrode groups.

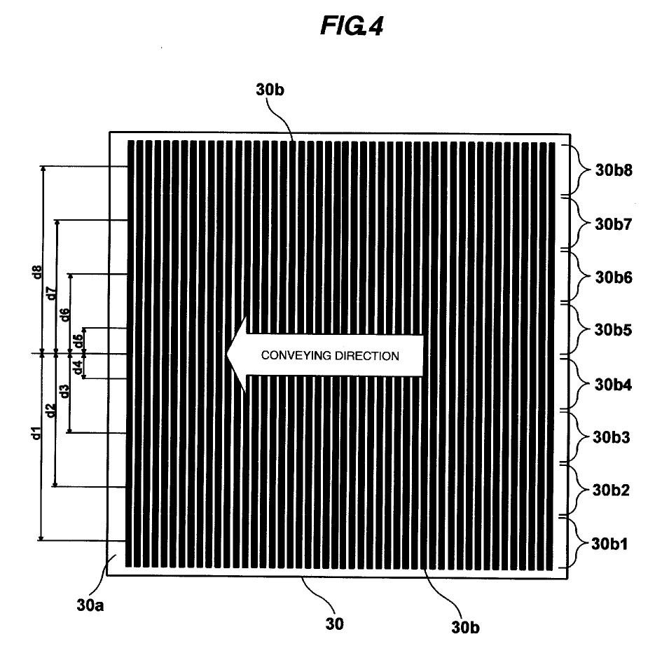

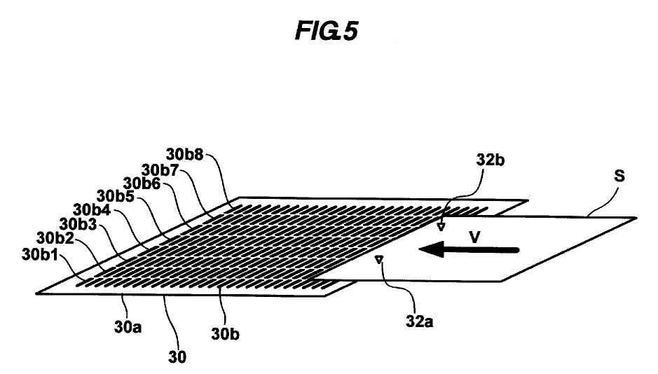

A specific configuration of the stator 30 included in the sheet conveying apparatus 29 will be described with reference to FIGS. 4 to 7.

In the configuration of the stator 30 included in the sheet conveying apparatus 29, many electrode groups including plural electrodes arranged in parallel in the sheet conveying direction are provided in a sheet width direction orthogonal to the conveying direction. As shown in FIG. 4, eight-line electrode groups 30b1 to 30b8 are arranged in the sheet width direction in the surface of the insulator 30a. As with the above-described principle, the conveying force is generated to the sheet. Three types of voltages Va1, Vb1, Vc1 to Va8, Vb8, and Vc8 are applied to the electrode groups 30b1 to 30b8 while being independent in each group. The voltages Va1, Vb1, Vc1 to Va8, Vb8, and Vc8 are applied which switched at predetermined conditions by the control unit 33. At least three lines are required for the electrode groups. Although the rotating and moving operations are smoothly performed as the number of lines of the electrode groups is increased, 4 to 12 lines of the electrode groups are optimum because the control becomes complicated when the number of lines of the electrode groups is excessively increased.

In conveying the sheet on the stator 30, a switching period of the voltages applied to the eight electrode groups 30b1 to 30b8 arranged in parallel in the sheet width direction is changed in each electrode group, whereby a sheet conveying speed can be changed in each electrode group. Furthermore, when the switching periods of the voltages applied to the electrode groups 30b1 to 30b8 are independently changed, the sheet conveying speeds differ from one another in the sheet width direction, which allows the sheet S to be rotated and moved according to the difference in speed.

As shown in FIGS. 1 and 5, a conveying path is formed such that the sheet passes through the stator 30. FIG. 6 is a plan view showing the state in which the sheet passes through the stator 30. As shown in FIG. 6A, sometimes the sheet S proceed into the stator 30 with an inclination angle X, when the sheet S is conveyed at a conveying speed V on the conveying path. In such cases, the sheet is conveyed at the conveying speed V as a whole. However, in order to correct the inclination angle X of the sheet S, it is necessary to make differences in conveying speeds V1 to V8 of the electrode groups 30b1 to 30b8. The conveying speeds V1 to V8 are equal to the conveying speed V of the whole of the sheet S in a central portion in the sheet width direction, a difference in speed between the conveying speeds V1 to V8 and the conveying speed V is increased toward an end portion from the center in the sheet width direction. That is, the conveying speed Vn is set in each electrode group according to the inclination angle X of the sheet S and a distance dn (n is the number of electrode groups) from the center in the sheet width direction of each electrode group.

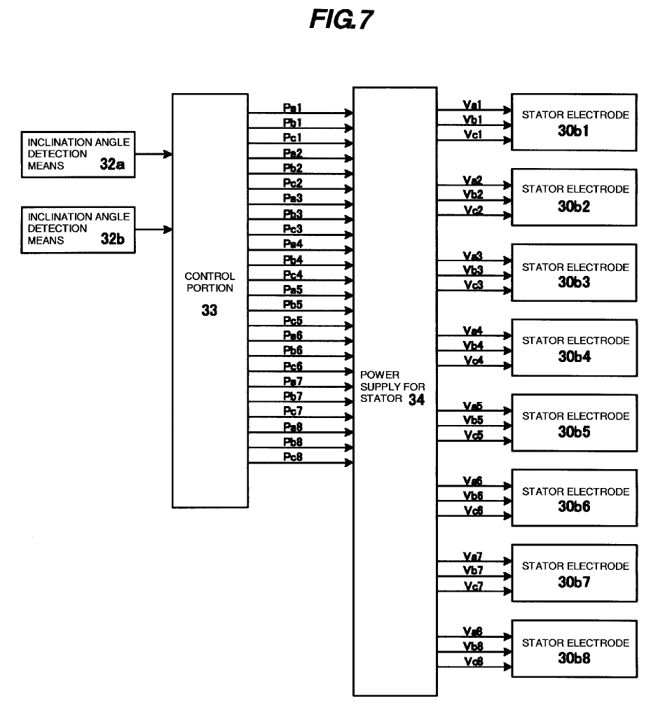

As shown in FIGS. 5 and 7, the inclination angle X of the sheet S is detected by inclination angle detection unit 32a and 32b for detecting the sheet inclination. The switching periods of the voltages applied to the electrode groups 30b1 to 30b8 are changed in each electrode group according to magnitude of each of the inclination angles X detected by the inclination angle detection unit 32a and 32b. That is, the conveying speeds V1 to V8 formed by the voltage patterns applied to the electrode groups 30b1 to 30b8 are set according to the magnitude of each of the detected inclination angles X. The conveying speeds are set in each electrode group by the following equations. In the following equations, f(x) is a predetermined value determined by the inclination angle X (see FIG. 6A) of sheet S, and f(dn) is a predetermined value determined by the distance dn (see FIG. 4) from the center of the electrode.

V1=V+f(x)×f(d1)

V2=V+f(x)×f(d2)

V3=V+f(x)×f(d3)

V4=V+f(x)×f(d4)

V5=V+f(x)×f(d5)

V6=V+f(x)×f(d6)

V7=V+f(x)×f(d7)

V8=V+f(x)×f(d8)

When the electrode groups convey the sheet S for a predetermined time at the set conveying speeds V1 to V8, the sheet S is conveyed in the conveying direction while rotated and moved, and the inclination angle X of the sheet S becomes zero degree to correct the skew feeding as shown in FIG. 6B. Therefore, the toner image can be transferred to the sheet at a desired angle to perform the printing.

As described above, the electrode groups 30b1 to 30b8 including the electrodes 30b arranged in parallel in the sheet conveying direction are provided in parallel in the direction orthogonal to the sheet conveying direction, and the conveying speeds of the electrode groups 30b1 to 30b8 can independently be changed. Therefore, even if the sheet is rotated to correct the sheet inclination, the difference in sheet conveying speeds V1 to V8 between the adjacent electrode groups can be decreased as much as possible. Accordingly, the skew feeding correction can be realized while even the sheet having the low stiffness is conveyed without applying the unnecessary stress.

The sheet conveying apparatus including the stator, in which the many electrode groups formed by the plural electrodes provided in parallel in the sheet conveying direction are provided in parallel in the sheet width direction, is used as the conveying portion of the image forming apparatus to perform the transverse registration correction before the transfer in the embodiment. However, the invention is not limited to the embodiment. For example, the sheet conveying apparatus including the stator may be used in another sheet conveying portion of the image forming apparatus or a sheet conveying portion of a sheet processing apparatus which processes the sheet received from the image forming apparatus.

In the embodiment, the eight electrode groups are illustrated as the many electrode groups provided in parallel in the sheet width direction in the embodiment. However, the invention is not limited to the embodiment, but the number of electrode groups, the number of electrodes in each electrode group, and a length of the electrode may appropriately be set according to application of the conveying portion.

Although the printer is illustrated as the image forming apparatus in the embodiment, the invention is not limited to the embodiment. For example, a scanner, a copying machine, and a facsimile or a multi function peripheral in which functions of the scanner, the copying machine, and the facsimile are combined may be used as the image forming apparatus. The same effects can be obtained by applying the invention to the sheet conveying apparatus used in the pieces of image forming apparatus.

Although the sheet conveying apparatus which is integral with the image forming apparatus is illustrated as the image forming apparatus in the embodiment, the invention is not limited to the embodiment. For example, a sheet conveying apparatus which is detachably attached to the image forming apparatus may be used, and the same effects can be obtained by applying the invention to the sheet conveying apparatus.

Although the sheet conveying apparatus which conveys the sheet such as the recording paper of the recording target is illustrated in the embodiment, the invention is not limited to the embodiment. For example, the same effect can be obtained even if the invention is applied to a sheet conveying apparatus which conveys a sheet such as a document of a reading target.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-308517, filed Nov. 15, 2006, which is hereby incorporated by reference herein in its entirety.

What is claimed is:

1. A sheet conveying apparatus comprising:
a stator in which many electrode groups are provided in parallel in a direction orthogonal to a sheet conveying direction, a plurality of belt-like electrodes being provided in parallel at predetermined intervals in the sheet conveying direction;
a power supply which applies at least two types of voltages to the electrode groups of the stator; and
a control unit which controls the at least two types of the voltages while switching the voltages applied to the electrode groups of the stator from the power supply,
wherein the control unit controls the voltages while switching the voltages applied to the electrodes such that the sheet is conveyed in a direction in which the electrodes of the stator are provided in parallel, and the control unit controls a switching period of the voltages applied to the electrode groups of the stator such that the switching period is changed in each electrode group to rotate the sheet.

2. The sheet conveying apparatus according to claim 1, comprising inclination angle detection unit which detects an inclination angle of the sheet,
wherein the switching periods of the voltages applied to the electrode groups are changed in each electrode group according to detection result of the inclination angle detection unit, and the sheet is rotated such that an inclination of the sheet is corrected.

3. An image forming apparatus which forms an image in a sheet, the image forming apparatus comprising a sheet conveying apparatus which conveys a sheet,
wherein the sheet conveying apparatus includes:
a stator in which many electrode groups are provided in parallel in a direction orthogonal to a sheet conveying direction, a plurality of belt-like electrodes being provided in parallel at predetermined intervals in the sheet conveying direction;
a power supply which applies at least two types of voltages to the electrode groups of the stator; and
a control unit which controls the at least two types of the voltages while switching the voltages applied to the electrode groups of the stator from the power supply, and
the control unit controls the voltages while switching the voltages applied to the electrodes such that the sheet is conveyed in a direction in which the electrodes of the stator are provided in parallel, and the control unit controls a switching period of the voltages applied to the electrode groups of the stator such that the switching period is changed in each electrode group to rotate the sheet.

4. The image forming apparatus according to claim 3, comprising inclination angle detection unit which detects an inclination angle of the sheet,
wherein the switching periods of the voltages applied to the electrode groups are changed in each electrode group according to detection result of the inclination angle detection unit, and the sheet is rotated such that an inclination of the sheet is corrected.
